(19) United States
(12) Patent Application Publication
(10) Pub. No.: US 2025/0252360 A1
(43) Pub. Date: Aug. 7, 2025

(54) METHOD AND SYSTEM USING ARTIFICIAL INTELLIGENCE FOR PREDICTING AGEING IMPACT OF LOADING ON DISTRIBUTION TRANSFORMERS

(71) Applicant: SAUDI ARABIAN OIL COMPANY, Dhahran (SA)

(72) Inventors: Khaled Mubarak Alshammari, Udhailiyah (SA); Fahad Qaed Alharbi, Al Hofuf (SA); Abdulrahman TAkrouni, Al Mubarraz (SA)

(73) Assignee: SAUDI ARABIAN OIL COMPANY, Dhahran (SA)

(21) Appl. No.: 18/433,997

(22) Filed: Feb. 6, 2024

(51) Int. Cl. G06N 20/20; G05B 23/02

(52) U.S. Cl. CPC G06N 20/20; G05B 23/0283

(57) ABSTRACT

A method includes obtaining static transformer data for a first transformer. The method includes obtaining dynamic transformer data for the first transformer. The method includes obtaining inspection transformer data regarding the first transformer. The method includes obtaining first maintenance data regarding the first transformer. The method includes obtaining first weather data regarding the first transformer. The method includes determining, by a computer processor, predicted distribution network integrity data using a first machine-learning model and the static transformer data, the dynamic transformer data, the inspection transformer data, the first maintenance data, and the first weather data. The first machine-learning model is trained using an ensemble learning algorithm. The method includes determining a transformer operation based on the predicted distribution network integrity data and transmitting a command to a control system coupled to the first transformer. The transformer operation is performed using the control system in response to receiving the command.

### BACKGROUND

Various operations are performed at an industrial site during the operation of the industrial site. Such operations may consume electrical power. Plant operations may, over time, expand in scope and subsequent power consumption, however, impact of the additional loading on the ageing of distribution transformers may not be reconciled. The ageing of transformers may have a substantial impact on distribution system efficiency. Thus, accurate ageing evaluations may enable efficient planning of plant operations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

This disclosure presents, in accordance with one or more embodiments a method that includes obtaining static transformer data for a first transformer. The static transformer data describes one or more transformer design parameters of the first transformer. The method includes obtaining dynamic transformer data for the first transformer. The dynamic transformer data describes one or more transformer operational parameters that change over a predetermined time period. The method includes obtaining inspection transformer data regarding the first transformer. The inspection transformer data includes data recorded from various inspection activities. The method includes obtaining first maintenance data regarding the first transformer. The first maintenance data includes data recorded from various maintenance activities. The method includes obtaining first weather data regarding the first transformer. The first weather data includes data recorded from various weather activities. The method includes determining, by a computer processor, predicted distribution network integrity data using a first machine-learning model and the static transformer data, the dynamic transformer data, the inspection transformer data, the first maintenance data, and the first weather data. The first machine-learning model is trained using an ensemble learning algorithm. The method includes determining, by the computer processor, a transformer operation based on the predicted distribution network integrity data and transmitting, by the computer processor, a command to a control system coupled to the first transformer. The transformer operation is performed using the control system in response to receiving the command.

This disclosure presents, in accordance with one or more embodiments a system that includes a plurality of servers, an electrical distribution site, and a distribution network manager coupled to the plurality of servers and to the electrical distribution site. The distribution network manager includes a computer processor. The distribution network manager includes functionality for obtaining static transformer data for a first transformer. The static transformer data describes one or more transformer design parameters of the first transformer. The functionality includes obtaining dynamic transformer data for the first transformer. The dynamic transformer data describes one or more transformer operational parameters that change over a predetermined time period. The functionality includes obtaining inspection transformer data regarding the first transformer and obtaining first maintenance data regarding the first transformer. The first maintenance data includes data recorded from various maintenance activities. The functionality includes determining, by a computer processor, predicted distribution network integrity data using a first machine-learning model and the static transformer data, the dynamic transformer data, the inspection transformer data, and the first maintenance data. The first machine-learning model is trained using an ensemble learning algorithm and the ensemble learning algorithm uses static transformer data and dynamic transformer data. The functionality includes determining, by the computer processor, a transformer operation based on the predicted distribution network integrity data and transmitting, by the computer processor, a command to a control system coupled to the first transformer. The transformer operation is performed using the control system in response to receiving the command.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1 and 2 show systems in accordance with one or more embodiments.

FIG. 3 shows a flowchart in accordance with one or more embodiments.

FIGS. 4 and 5 show examples in accordance with one or more embodiments.

FIG. 6 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for determining an electrical distribution network integrity scenario using machine learning (ML). In some embodiments, for example, a transformer operation such as a transformer replacement operation may include various load considerations based on issues such as addition of load, reduction of load, and cycling of load, changes of safety integrity level (SIL), transformer thermal models, static data such as design parameters, dynamic data such as temperature, weather data such as weather conditions, historical data such as failure history, maintenance history, and preventive maintenance history.

As such, human forecasting of the impact of adding additional loads in a plant facility on a distribution transformer age may be a tedious process that is difficult to forecast based on changing grid scenarios. Likewise, human planners may miss important transformer load criteria for avoiding malfunctions and breakdowns. Accordingly, some embodiments include a distribution network manager that may be a transformer AI predictive tool, a “smart system” or “expert system” that automatically acquires, obtains, calculates, determines, and/or readjusts distribution transformer age forecast criteria for an electrical distribution network integrity scenario for one or more transformer operations. In other words, a distribution network manager may be an artificial intelligence entity operation on an electrical distribution management network (e.g., as a network controller) that performs such functionality.

Moreover, some embodiments include a distribution network manager with self-decision functionality that operates independently and with flexibility. For example, the distribution network manager may perform a learning process that detects unusual items not involved for forecasting purposes. For example, a distribution network manager may determine statistical trends based on transformer data (such as static and dynamic log data), maintenance data, weather data, and/or inspection data. Likewise, a distribution network manager may determine one or more additional values or weights for arranging the modeling of the transformer integrity. This flexibility may accommodate changes in real time and on the fly observed matters, like safety concerns, alternate transformer interactions (other components, other service entities and scheduling criteria, such as capital improvements, preventive maintenance (daily, weekly, monthly, quarterly, yearly), government factors such as changes to codes and inspections, weather factors, safety factors, legal/contractual factors, etc.). The flexibility of the distribution network manager builds trends and improves robustness of various electrical distribution network integrity scenarios by advising about possible issues. These different factors may provide the data inputs that are adjusted over time to optimize a particular distribution transformer age forecasting criterion.

Furthermore, some embodiments use one or more machine learning algorithms to determine which data inputs to use for a distribution transformer age forecasting criterion. For example, different sets of data inputs may maximize operational efficiency and throughput/production at one or more plant facilities, while also minimizing operational costs for those same plant facilities. For example, an optimized set of data inputs may be a subset of a larger aggregated set of data inputs identified over a distribution management network. These aggregated data inputs may be recognized by a distribution network manager, where the distribution network manager assigns different weights or significances to various data inputs. Thus, a distribution network manager may provide a flexible method to accommodate multiple distribution transformer age forecasting criteria (e.g., swapping importance/relevance of different data inputs wherein the relevance corresponds to various additional loads, incidents, costs, codes, inspections, etc.) in real-time to re-arrange different electrical distribution network integrity scenarios. Thus, a distribution network manager may automatically readjust variables for an electrical distribution network integrity scenario based on predicting their future importance to a user. In some embodiments, an electrical distribution network integrity scenario may be updated based on real-time observed matters during actual performance of the electrical distribution network integrity scenario (e.g., in response to changing loads, new additions to historical failure, maintenance, and preventive maintenance data, safety concerns, weather concerns, maintenance plans, and preventive maintenance plans related to implementation of the integrity scenario, etc.). The computer processor may generate one or more electrical distribution network integrity scenarios that correspond to one or more different electrical distribution network integrity criteria. The distribution network manager may automatically readjust an electrical distribution network integrity criterion

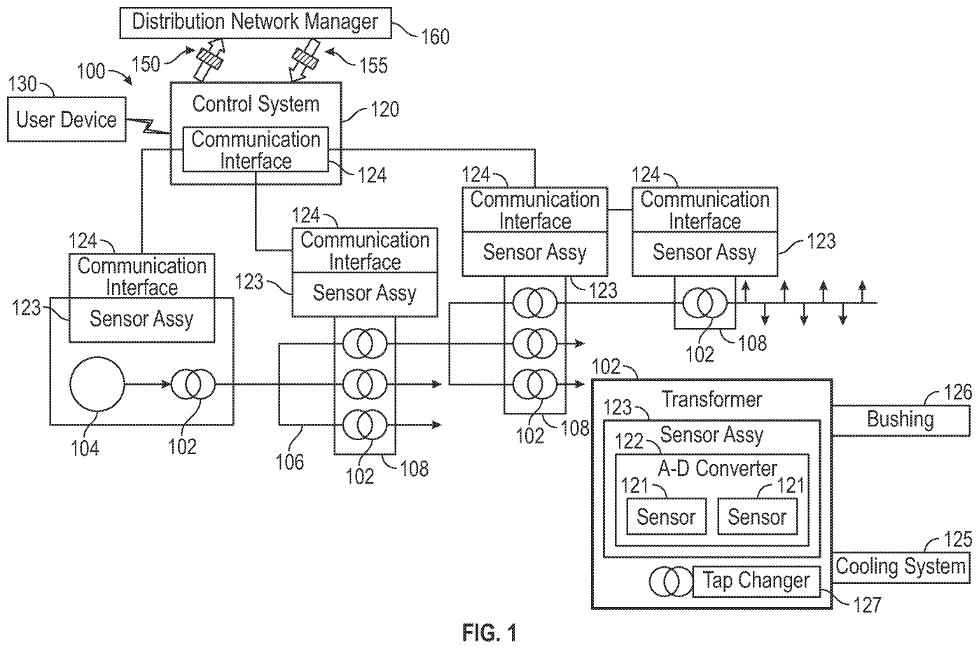

Turning to FIG. 1, FIG. 1 shows an electrical distribution network (e.g., a grid 100) at an electrical distribution site with various transformers (e.g., a transformer 102). FIG. 1 shows in schematic form that if a transformer fails, then the grid integrity is impacted. A transformer ageing prematurely may indicate an impending grid integrity impact. Various integrity scenarios may be determined by evaluating transformer failures. A transformer ageing prematurely may be referred to as problematic (or a problematic transformer) and a transformer not ageing prematurely may be referred to as non-problematic. Loading a transformer may impact the transformer ageing and therefore create a grid integrity scenario. Cycling the load on a transformer may impact the transformer ageing. Therefore, a benefit to the grid integrity may be achieved by forecasting the impact of adding additional loads in the plant facility on distribution transformer age.

FIG. 1 transformers are used for stepping up (increasing) a voltage or are used for stepping down (decreasing) a voltage. Transformers may include a cooling system 125. Water-cooled cables may connect the grid with the transformer. The transformer may be installed in a vault cooled by pump-circulated transformer oil. The transformer oil may be cooled by water via water-to-oil heat exchangers or by air via air-to-oil heat exchangers. Heat exchangers may operate with counter-current or parallel flows. Bushings (e.g., bushing 126) couple the transformer to the grid and convey electric current through a conducting barrier such as the case of the transformer. Transformers may include a sensor assembly (e.g., a sensor assembly 123). Transformer examples include a yard transformer shown electrically connected to a source of electric power generation (generator 104). The electric power may be defined by its electric potential described by units of volts and its electric current described by units of amperes or amps. The generator output may be generated at, for example, tens of thousands of volts alternating current (VAC).

The yard transformer may increase the voltage for transmission to a voltage of, for example, hundreds of thousands of VAC. The power may travel through the yard transformer and then the power is transmitted through one or more transmission systems such as primary transmission, secondary transmission, high-voltage distribution, final distribution, low-voltage distribution (a transmission 106). From the transmission system the power is transmitted to one or more distribution substations such as regional substations, zone substations, and distribution substations (a substation 108). At a substation, the voltage may be reduced using another transformer to a voltage of, for example, mid-hundreds of thousands of volts to less than one hundred thousand volts. From the substations the power is delivered through another one or more of the transmission systems to other substations. The power may be further stepped down by transformers to tens of thousands of volts. At each step up or step down a transformer is used.

The transformers have various electrical specifications and various properties such as mechanical, electrical, and cooling system properties. The transformers have various configurations such as mounting systems, bushing orientations, and electrical insulation gases, liquids, and solids. Each transformer system of properties, configurations, bushings and their orientations, and isolators and their mediums is provided by various manufacturers. Each system subcomponent has various duty cycle specifications and maintenance schedules and subsequently sparing philosophies, sparing inventories, and sparing warehousing. Transformers and other components of the electrical distribution network may require various inspection activities for regulatory compliance, mechanical inspection, and electrical inspection. Managing the integrity of the system of transformers may include all these inputs. A distribution network manager 160 keeps track of the inputs and may be coupled to a control system 120.

The control system 120 may include one or more user devices (e.g., a user device 130) that include hardware and/or software with functionality to control one or more processes performed by the electrical distribution network (e.g., the grid 100). For example, the user device may include software such as an operator dashboard that, for example, may present data to a user and may receive user input. The control system may couple with a preventative maintenance database and/or sub-system. Specifically, a user device may control cooling system pumps, heat exchangers, fans, valve states, fluid levels, pipe pressures, warning alarms, and/or pressure releases throughout a transformer assembly and/or a grid. In particular, the control system may include a programmable logic controller (PLC). The PLC may be a ruggedized computer system with functionality to withstand vibrations, extreme temperatures, wet conditions, and/or dusty conditions, for example, around the grid.

Without loss of generality, the term “control system” may refer to an electrical distribution management network that is used to operate and control the equipment, or a grid data acquisition and monitoring system that is used to acquire electrical distribution processes and equipment data and to monitor the operation of the electrical distribution process, or an electrical distribution software system that is used to analyze and understand electrical distribution events and status. For example, the control system 120 may be coupled to the sensor assembly 123 in order to perform various program functions for transformer cooling, tap changer motor drive unit (MDU) cooling, etc. While one of control system 120 is shown in FIG. 1, the grid 100 may include multiple control systems for managing various electrical distribution operations, maintenance operations, inspection operations, and/or other transformer operations.

As further shown in FIG. 1, sensors 121 may be included in the sensor assembly 123, which is positioned adjacent to the transformer 102 and configured to provide transformer data about the grid. Sensors 121 may also be coupled to a communication interface 124 that includes a processor, memory, and an analog-to-digital converter 122 for processing sensor measurements. For example, the sensors 121 may include gas sensors, oil level sensors, and temperature sensors such as oil temperature indicators (OTI) and winding temperature indicators (WTI).

Likewise, the sensors 121 may include other types of sensors, such as transmitters and receivers to measure operational parameters and provide the transformer data to a control system. For example, a Buchholz relay may be used to detect gas in the transformer oil. Oil decomposition may result in generation of various gases such as hydrocarbon gases, carbon monoxide, and carbon dioxide. Detection of the gas may indicate the chemical breakdown, e.g., the decomposition of the transformer oil. The gases may in turn may indicate a further problem such as an insulation fault between turns, a breakdown of core of the transformer, and/or a heating of the core.

The sensors 121 may include hardware and/or software for generating different types of transformer logs (such as temperature logs or current logs) that may provide transformer data about the grid, including failures of grid sections and many other pieces of information about the grid. If such transformer data is acquired during electrical distribution operations, then the information may be used to make adjustments to electrical distribution operations in real-time.

FIG. 1 sensors 121 may be sensors for oil temperature, winding temperature, ambient temperature, oil level, tank pressure, moisture content, bubbling temperature, ageing rate, status signal, and relay signal. The transformer may include hot spot sensors such as high voltage winding hot spot, low voltage winding hot spot, medium voltage winding hot spot, and/or core hot spot.

Sensors may be included for monitoring of tap changers (TC) (e.g., tap changer 127) such as no-load tap changers (NLTC), off-circuit tap changers (OCTC), or de-energized tap changers (DETC), and on-load tap changers (OLTC). Tap changer sensors may include tap position and contact wear, as well as tap changer MDU sensors for TC current, TC voltage, TC torque, and TC power consumption. Tap changer sensors may include TC chamber oil/gas temperature, oil level/gas pressure, partial discharge (PD), and dissolved gases. Sensors may be included in a relay and control panel (R&C) and in a remote tap changer control (RTCC) panel. Sensors may monitor the performance of relay, alarms, and control switches in the R&C panels and in the RTCC panels.

Transformer sensors may include on-line Tan δ bushing monitoring in power factor (PF)/dissipation factor percentage, i.e., 4% PF or 8% PF, and in capacitance in units of picofarads (pF). Monitoring sensors may include partial discharge in high-frequency (HF), ultra-high frequency (UHF), and/or optical sensor variations; dissolved gas analyzer (DGA) in variations using gas chromatography (GC), photoacoustic spectroscopy (PAS), and/or nondispersive infrared (NDIR); transient over-voltage; geomagnetic induced current (GIC) monitoring; and/or vibration monitoring, acoustic sensors, accelerometers, measurement microphones, contact microphones, and hydrophones.

Transformer sensors may include those for load, power, and losses, such as load/over current; active/reactive power; overload capacity/duration; and/or power factor/losses. Transformer sensors may include those for cooling monitoring and/or control such as fan/pump condition; motor condition; cooling control; cooling efficiency; oil/water flow; and/or inlet/outlet oil temperature.

In some embodiments, acoustic sensors may be installed in a transformer fluid circulation system of the transformer cooling system (e.g., the cooling system 125) to record acoustic cooling signals in real-time. Cooling acoustic signals may transmit through the cooling fluid to be recorded by the acoustic sensors located in the cooling fluid circulation system. The recorded cooling fluid acoustic signals may be processed and analyzed to determine transformer data, such as temperature properties of the transformer and the cooling system. This transformer data may be used in various applications, such as managing the electrical distribution network, etc.

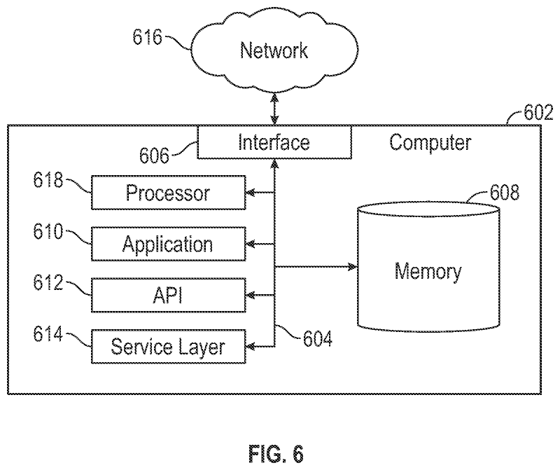

In some embodiments, a distribution network manager 160 is coupled to one or more control systems (e.g., control system 120) at a plant facility. For example, a distribution network manager 160 may include hardware and/or software to collect grid operation data such as transformer data (e.g., xfmr data 150) from one or more plant facilities. Likewise, the distribution network manager 160 may monitor various distribution management network operations performed by various components and/or service entities. In some embodiments, a distribution network manager 160 is a controller located on a server remote from the plant facility. In some embodiments, a distribution network manager 160 may be similar to a control system coupled to the grid 100. In some embodiments, the distribution network manager 160 may include a computer system that is similar to the computer system (e.g., a computer 602) described below with regard to FIG. 6 and the accompanying description.

In some embodiments, transformer operations may include various monitoring, inspection, preventive maintenance, corrective maintenance, reinforcing, preservation, rehabilitation, restoration, reconstruction, and maintenance, repair, and overhaul (MRO) operations carried out by one or more service entities for an electrical power distribution grid, for a plant facility, for other grid components, and/or for the transformer. Maintenance may include routine or as-needed (ad hoc) maintenance. As-needed maintenance may be emergency maintenance following a breakdown. Condition maintenance may prevent breakdown maintenance. In some embodiments, transformer operations provide transformer diagnostics, and/or manage the grid. With respect to service entities, a service entity may be a company or other actor that performs one or more types of grid services, such as weather operations (weather reporting services), maintenance operations, inspection operations, grid operations, and transformer operations at the plant facility. For example, one or more service entities may be responsible for performing a transformer replacement operation or a transformer maintenance operation such as a bushing replacement operation on a transformer. Another maintenance example performed by a service entity is the replacement of a silica gel breather, a painting operation, a fastener torque operation, etc. For example, a transformer operation may be selected from a group consisting of the transformer maintenance operation and the transformer replacement operation.

Moreover, a distribution network manager 160 may include functionality for coordinating various grid services, such as transformer intervention using various commands (e.g., command 155), e.g., by transmitting commands to various network devices (e.g., control system 120) in a grid as well as various user devices at the plant facility. In some embodiments, for example, a command is a network message that automatically assigns or reassigns tasks or operations to various components and/or service entities at a plant facility. For example, a distribution network manager 160 may communicate with one or more service entities through various user devices, e.g., by receiving periodic status reports, sending messages through user interfaces, etc. Likewise, the distribution network manager 160 may also collect other ageing prediction data regarding load and/or addition of load, such as sensor data from the grid 100, service provider data, feedback through a human machine interface from other personnel at the plant facility, and/or data from a historian operating at the plant facility.

The distribution network manager 160 may have functionality for automatically obtaining maintenance data from a maintenance server after the control system on an electrical distribution network uploads information regarding a completed maintenance operation such as a transformer replacement, transformer repair, transformer intervention, etc. For example, the distribution network manager may automatically obtain first maintenance data from a maintenance server. The first maintenance data may describe a respective maintenance status of a respective transformer of interest among one or more transformers. The respective maintenance status may represent the maintenance status for a respective time period for which the respective transformer of interest was operating.

In like manner, the distribution network manager 160 may have functionality for automatically obtaining weather data from a weather server and inspection data from an inspection server after the control system uploads information regarding a completed weather report or inspection operation, respectively. A weather report may include weather temperature data, weather dust data, weather wind data, weather rain data, etc. The distribution network manager 160 may be a computer system similar to the computer 602 described below in FIG. 6 and the accompanying description.

In some embodiments, a distribution network manager 160 may include software configured with machine learning (ML) capabilities and artificial intelligence (AI) that learn from trends of the one or more parameters tracked by the control system. In one or more embodiments, the AI and the ML capabilities employed by the network manager may include any suitable algorithms and processes for predicting transformer ageing using historical data as an input. For example, the ML models or algorithms may include supervised algorithms, unsupervised algorithms, deep learning algorithms that use artificial neural networks (ANN), etc. More specifically, supervised ML models include classification, regression models, (support vector machines or support vector networks) etc. Unsupervised ML models include, for example, clustering models.

Deep-learning algorithms are a part of ML algorithms based on artificial neural networks with representation learning. For example, the deep-learning algorithm may run data through multiple layers of neural network algorithms, each of which passes a simplified representation of the data to the next layer. With respect to neural networks (e.g., artificial neural networks), for example, a neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights and biases for adjusting the data inputs.

These network weights and biases may amplify or reduce the value of a particular data input, thereby assigning an amount of significance to various data inputs for a task being modeled. Through machine learning, a neural network may determine which data inputs should receive greater priority in determining one or more specified outputs of the neural network. Likewise, these weighted data inputs may be summed such that this sum is communicated through an activation function of a neuron to other hidden layers within the neural network. As such, the activation function may determine whether, and to what extent, an output of a neuron progresses to other neurons where the output may be weighted again for use as an input to the next hidden layer. Input variables are selected based on their relevance (weighting, importance, etc.) to downhole communication issues. Feature engineering techniques may be utilized to extract meaningful information and create derived features.

In some embodiments, a machine-learning model may include an encoder model that transforms input data to a latent representation vector. The machine-learning model may further amalgamate the latent representation vector with a vector representation of a particular parameterization to produced combined data, e.g., using in a latent space domain. Likewise, the machine-learning model may also include a decoder model that transforms the combined vector into the corresponding output data according to the parameterization.

In some embodiments, the machine-learning model is a variational autoencoder. For example, variational autoencoders may compress input information into a constrained multivariate latent distribution through encoding in order to reconstruct the information during a decoding process. Thus, variational autoencoders may be used in unsupervised, semi-supervised, and/or supervised machine-learning algorithms. More specifically, variational autoencoders may perform a dimensionality reduction that reduces the number of features within an input dataset (such as an input gather). This dimensionality reduction may be performed by selection (e.g., only some existing features are preserved) or by extraction (e.g., a reduced number of new features are produced from preexisting features). Thus, an encoder process may compress the input data (i.e., from an initial space to an encoded space or latent space), while a decoder process may decompress the compressed data. This compression may be lossy, such that a portion of the original information in the input dataset cannot be recovered during the decoding process.

In some embodiments, various types of machine-learning algorithms may be used to train the model that is used to predict behavior in transformers, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function.”) The error function may be based on various criteria, such as mean squared error function, a similarity function, etc., where the error function may be used as a feedback mechanism for tuning weights in the electronic model.

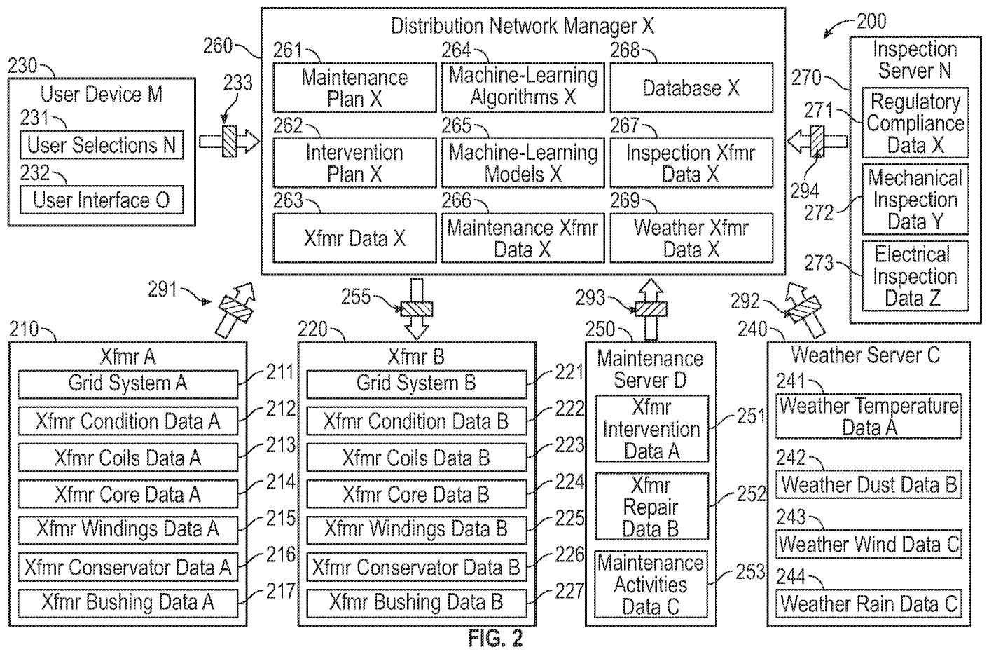

In one or more embodiments, the network manager includes one or more ML models (e.g., one or more of an ML model X 265, FIG. 2) for determining an electrical distribution network integrity scenario using data inputs. For example, a distribution transformer age forecasting criterion may correspond to a specific set of data inputs that may be adjusted (e.g., data inputs added and/or removed) to modify the electrical distribution network integrity scenario. For example, artificial intelligence (AI) techniques may assist a distribution network manager in linking contributions of different components and/or service entities to a preventive maintenance process (i.e., a preventive maintenance process that includes one or more ageing predictions) to evaluate and/or forecast the impact of adding additional loads in the plant facility on distribution transformer age. In some embodiments, for example, a distribution network manager 160 uses one or more of the ML model X 265 to determine an electrical distribution network integrity scenario for measuring a contribution of a service entity to a particular transformer intervention. For more information regarding distribution transformer age forecasting, see FIGS. 2, 4 and 5 below and the accompanying description.

Turning to FIG. 2, FIG. 2 shows a schematic diagram in accordance with one or more embodiments. As shown in FIG. 2, a distribution management network (e.g., a distribution management network A 200) may include a distribution network manager (e.g., distribution network manager X 260), various transformers (e.g., xfmr A 210 and xfmr B 220), various servers (e.g., weather server C 240, maintenance server D 250, inspection server N 270), and various user devices (e.g., user device M 230), and/or various network elements (not shown).

A transformer (xfmr) (e.g., the xfmr A 210 and the xfmr B 220) may be part of an electrical distribution network (e.g., grid system A 211, grid system B 221) that is similar to the electrical distribution network (e.g., the grid 100) described above in FIG. 1 and the accompanying description. In some embodiments, various types of transformer data (e.g., xfmr data A 291) are collected over the distribution management network, such as xfmr condition data (e.g., xfmr condition data A 212, xfmr condition data B 222), xfmr coils data (e.g., coils data A 213, coils data B 223), xfmr core data (e.g., xfmr core data A 214, xfmr core data B 224), xfmr windings data (e.g., xfmr windings data A 215, xfmr windings data B 225), xfmr conservator data (e.g., xfmr conservator data A 216, xfmr conservator data B 226), and/or xfmr bushing data (e.g., xfmr bushing data A 217, xfmr bushing data B 227).

Likewise, the distribution management network may also collect data regarding other transformer activities data (such as a user input, e.g., user data 233, and/or weather xfmr data 292, maintenance xfmr data 293, inspection xfmr data 294) from one or more user devices and/or data servers (e.g., user device M 230, weather server C 240, maintenance server D 250, inspection server N 270).

For example, transformer design data may describe various design specifications of a transformer and as such is transformer static data. Transformer data may describe conditions at one or more transformers, such as data corresponding to grid conditions, coil conditions, core conditions, windings conditions, conservator conditions, bushing conditions, etc., and as such is transformer dynamic data.

Weather transformer data (e.g., weather xfmr data 292) may include information describing temperature data (e.g., weather temperature data A 241), dust data (e.g., weather dust data B 242), wind data (e.g., weather wind data C 243), rain and/or snow precipitation/accumulation data (e.g., weather rain data C 244), etc.

Maintenance transformer data (e.g., maintenance xfmr data 293) may include information describing transformer interventions (e.g., xfmr intervention data A 251), transformer repairs (e.g., xfmr repair data B 252), and transformer maintenance activities (e.g., xfmr maintenance activities data C 253), etc.

Inspection transformer data (e.g., inspection xfmr data 294) may include information describing regulator inspections (e.g., regulatory compliance data X 271), mechanical inspections (e.g., mechanical inspection data Y 272), electrical inspections (e.g., electrical inspection data Z 273), etc.

In some embodiments, the various servers may be remote servers that include hardware and/or software with functionality for managing and/or tracking the user input (e.g., user data), the transformer data, the weather transformer data, the maintenance transformer data, and the inspection transformer data. For example, a maintenance server may be a remote server that includes hardware and/or software with functionality for managing and/or tracking transformer maintenance activities. For example, the inspection server may obtain maintenance data regarding various maintenance activities. A maintenance server may obtain the data and then maintain the maintenance data on transformers and various transformer maintenance activities for a particular time period.

Maintenance examples include filling and/or changing the transformer oil level, replacing the silica gel breather (e.g., replacing if the gel color does not meet expectations, i.e., a predetermined criterion), filling and/or replacing the bushing oil level (e.g., at an oil level sight gauge), and, upon determining that a reading on a magnetic oil gauge (MOG) does not meet specification, then filling and/or replacing the oil. A maintenance example includes taking an action after an inspection reveals that the composition of gases collected from the transformer oil such as accumulated gases collected from the gas release pockets on the top of a Buchholz relay do not meet specification. The maintenance server may obtain the maintenance data from various maintenance entities such as maintenance service providers. Maintenance service providers may be accredited by an industry agency such as the International Electrical Testing Association (NETA).

Likewise, a remote server may be a server that communicates to various plant facilities over the Internet or through a cloud computing environment. For example, when a transformer has been maintained for various ageing predictions, the current or future maintenance data of the respective transformer may be logged automatically with the maintenance server (e.g., by detecting a scan of an identifier unique to a respective transformer. A maintenance entity may upload the data from a user device to a server.) Accordingly, a maintenance server may transmit maintenance data to a distribution network manager.

In some embodiments, an inspection server is a remote server that includes hardware and/or software for managing and tracking inspection data. For example, the inspection server may obtain inspection data regarding various regulatory compliance entities, mechanical inspection entities, electrical inspection entities, etc. The inspection server may obtain the inspection data from various inspection entities such as inspection service providers. Inspection service providers may be accredited by an industry agency such as NETA. When a transformer has been inspected for ageing predictions, the inspection data may be logged automatically with the inspection server and transmitted to a distribution network manager. Accordingly, an inspection server may transmit inspection data to a distribution network manager.

In some embodiments, a weather server is a remote server that includes hardware and/or software for managing and tracking weather data. For example, the weather server may obtain weather data regarding various weather characteristics such as temperature data, dust data, wind data, rain data, etc. The weather server may obtain the weather data from various weather entities such as weather service providers, weather instrumentation, weather sensors, etc. When a transformer has been subjected to weather conditions used for the ageing predictions, the weather data may be logged automatically with the weather server and transmitted to a distribution network manager. The ageing predictions may use weather data from weather activities such as weather historical data research, weather predictions, weather forecasts, and weather outlooks. Accordingly, a weather server may transmit weather data to a distribution network manager.

In some embodiments, the distribution network manager (e.g., distribution network manager X 260) may include hardware and/or software that obtain a maintenance plan (e.g., maintenance plan X 261) regarding transformer maintenance activities, an intervention plan (e.g., intervention plan X 262) regarding transformer intervention activities, transformer data (e.g., xfmr data X 263), maintenance transformer data (e.g., maintenance xfmr data X 266), inspection transformer data (e.g., inspection xfmr data X 267), and/or weather transformer data (e.g., weather xfmr data X 269) from data inputs (e.g., user data 233, xfmr data A 291, weather xfmr data 292, maintenance xfmr data 293, inspection xfmr data 294).

For example, the distribution network manager (e.g., distribution network manager X 260) acquires the maintenance plan (e.g., maintenance plan X 261) from user data 233 collected by a user device (e.g., user device M 230). The user device (e.g., user device M 230) may include hardware and/or software to receive real-time user selections (e.g., user selections N 231) by interacting with a user via a user interface (e.g., user interface O 232). For example, the user may select distribution transformer age forecasting criterion of cooling system functions. The user may select distribution transformer age forecasting criterion such as automatic mode, remote mode, and manual mode for the cooling system oil pump(s), air fan(s), and other items. The user may send a user command to the control system to perform the user selection. The user command may change the electrical distribution network integrity scenario according to the distribution transformer age forecasting criterion.

Specifically, the distribution network manager (e.g., distribution network manager X 260) allows the user to interact with the user device (e.g., user device M 230) to verify that the actual electrical distribution network integrity scenario setup is as per an acceptance criterion such as a user desire (a user input), and to monitor the performance as the self-learning process of the ML algorithm is set up for feedback upon the actual events. When the electrical distribution network integrity scenario setup is not as desired (e.g., the setup does not satisfy the acceptance criterion), the user can modify the user selections (e.g., user selections N 231) to adjust the distribution transformer age forecasting criterion via the graphical display (e.g., user interface O 232).

Keeping with FIG. 2, in some embodiments, the distribution network manager (e.g., distribution network manager X 260) may include hardware and/or software to generate one or more electrical distribution network integrity scenarios within the distribution management network (e.g., distribution management network A 200) using one or more ML algorithms (e.g., ML algorithms X 264) based on the obtained distribution transformer age forecasting criterion and transformer intervention activities. For example, a distribution network manager may implement machine learning by gathering data from actual transformer data (e.g., status updates at a plant facility regarding one or more ageing predictions) and real events to adjust a particular distribution transformer age forecasting criterion and/or logical inputs regarding flexibility for the operational plans of a plant facility year, month, and week.

Thus, different inputs (e.g., types of data or different data sources) may provide the initial setup of a particular distribution transformer age forecasting criterion, where the data inputs may be customized according to different electrical distribution network integrity scenarios to better arrange a forward schedule as a transformer intervention plan. The distribution network manager is self-maintained on data storage and usage for feedback; thus, the distribution network manager may require minimal supervision of human interaction. In some embodiments, the distribution network manager advises a user about an electrical distribution network integrity scenario when the learning process detects possible related concerns that a human might miss due to the amount of variables and possible related issues. For example, an advisement may be a message prompt in a graphical user interface managed by the distribution network manager.

In some embodiments, for example, the distribution network manager (e.g., distribution network manager X 260) applies one or more ML algorithms (e.g., an unsupervised ML algorithm, a reinforcement ML algorithm, a self-supervised ML algorithm, etc.) to train a model (e.g., the ML model X 265). Specifically, the distribution network manager (e.g., distribution network manager X 260) applies the model to generate an electrical distribution network integrity scenario at a plant facility using data inputs regarding one or more distribution transformer age forecasting criterion and one or more transformer conditions.

With respect to ML models, different types of ML models may be used, such as random forest models and artificial neural networks, such as convolutional neural networks, deep neural networks, recurrent neural networks, support vector machines (SVMs), naive Bayes models, ridge classifier models, gradient boosting models, decision trees, unsupervised learning models, reinforcement learning models, self-supervised learning models, supervised learning models, inductive learning models (supervised learning), deductive learning models (deductive reasoning), etc. In some embodiments, a distribution network manager may generate augmented or synthetic data to produce a large amount of interpreted data for training a particular model.

Likewise, an ML model may be trained using one or more ML algorithms. For example, a backpropagation algorithm may be used to train a neural network. The training data may include the predetermined distribution transformer age forecasting and data inputs from historical events regarding one or more transformer intervention activities and one or more transformer conditions. A distribution network manager may continue to train the ML model by self-feeding database (e.g., database X 268) for the historical learning process. Thus, the ML model predicts the electrical distribution network integrity scenario for performance as the self-learning process of the algorithm is setup for feedback upon the actual events as per an acceptance criterion, e.g., a user desire.

With respect to neural networks, for example, a neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine learning, a neural network may determine which data inputs should receive greater priority in determining one or more specified outputs of the neural network. Likewise, these weighted data inputs may be summed such that this sum is communicated through an activation function of a neuron to other hidden layers within the neural network. As such, the activation function may determine whether and to what extent an output of a neuron progresses to other neurons where the output may be weighted again for use as an input to the next hidden layer.

In a deep neural network, for example, a layer of neurons may be trained on a predetermined list of features based on the previous network layer's output. Thus, as data progresses through the deep neural network, more complex features may be identified within the data by neurons in later layers. Likewise, a U-net model or other type of convolutional neural network model may include various convolutional layers, pooling layers, fully connected layers, and/or normalization layers to produce a particular type of output. Thus, convolution and pooling functions may be the activation functions within a convolutional neural network.

In some embodiments, two or more different types of machine-learning models are integrated into a single machine-learning architecture, e.g., a machine-learning model may include a random forest model and various neural networks. In some embodiments, a machine-learning model is trained using multiple epochs. For example, an epoch may be an iteration of a model through a portion or all of a training dataset. As such, a single machine-learning epoch may correspond to a specific batch of training data, where the training data is divided into multiple batches for multiple epochs. Thus, a machine-learning model may be trained iteratively using epochs until the model achieves a predetermined criterion, such as predetermined level of prediction accuracy or training over a specific number of machine-learning epochs or iterations. Thus, better training of a model may lead to better predictions by a trained model. In this manner an initial model (an initial machine-learning model) may be sent to a training operation to produce a second machine-learning model.

Turning to recurrent neural networks, a recurrent neural network (RNN) may perform a particular task repeatedly for multiple data elements in an input sequence (e.g., a sequence of temperature values or flow rate values), with the output of the recurrent neural network being dependent on past computations.

As such, a recurrent neural network may operate with a memory or hidden cell state, which provides information for use by the current cell computation with respect to the current data input. For example, a recurrent neural network may resemble a chain-like structure of RNN cells, where different types of recurrent neural networks may have different types of repeating RNN cells.

Likewise, the input sequence may be time-series data, where hidden cell states may have different values at different time steps during a prediction or training operation. For example, where a deep neural network may use different parameters at each hidden layer, a recurrent neural network may have common parameters in an RNN cell, which may be performed across multiple time steps.

To train a recurrent neural network, a supervised learning algorithm such as a backpropagation algorithm may also be used. In some embodiments, the backpropagation algorithm is a backpropagation through time (BPTT) algorithm. Likewise, a BPTT algorithm may determine gradients to update various hidden layers and neurons within a recurrent neural network in a similar manner as used to train various deep neural networks.

Embodiments are contemplated with different types of RNNs. For example, classic RNNs, long short-term memory (LSTM) networks, a gated recurrent unit (GRU), a stacked LSTM that includes multiple hidden LSTM layers (i.e., each LSTM layer includes multiple RNN cells), recurrent neural networks with attention (i.e., the machine-learning model may focus attention on specific elements in an input sequence), bidirectional recurrent neural networks (e.g., a machine-learning model that may be trained in both time directions simultaneously, with separate hidden layers, such as forward layers and backward layers), as well as multidimensional LSTM networks, graph recurrent neural networks, grid recurrent neural networks, etc. With regard to LSTM networks, an LSTM cell may include various output lines that carry vectors of information, e.g., from the output of one LSTM cell to the input of another LSTM cell. Thus, an LSTM cell may include multiple hidden layers as well as various pointwise operation units that perform computations such as vector addition.

In some embodiments, a reservoir simulator uses one or more ensemble learning methods to produce a hybrid-model architecture. For example, an ensemble learning method may use multiple types of machine-learning models to obtain better predictive performance than available with a single machine-learning model. In some embodiments, for example, an ensemble architecture may combine multiple base models to produce a single machine-learning model. The ensemble model, comprising multiple base models, is trained using a prepared dataset, i.e., the relevant data, both problematic and non-problematic, to which data preprocessing techniques have been applied and feature engineering techniques have been utilized.

One example of an ensemble learning method is a BAGGing model (i.e., BAGGing refers to a model that performs bootstrapping and aggregation operations) that combines predictions from multiple neural networks to add a bias that reduces variance of a single trained neural network model. Another ensemble learning method includes a stacking method, which may involve fitting many different model types on the same data and using another machine-learning model to combine various predictions. In this manner an initial model (an initial machine-learning model) may be sent to a training operation to produce a second machine-learning model using a bootstrap and aggregation operation. Gradient boosting for regression and classification tasks provides a prediction model in the form of an ensemble of weak prediction models, i.e., models that make very few assumptions about the data, which are typically simple decision trees.

Turning to random forests, a random forest model may be an algorithmic model that combines the output of multiple decision trees to reach a single predicted result. For example, a random forest model may be composed of a collection of decision trees and/or decision tree nodes, where training the random forest model may be based on three main hyperparameters that include node size, a number of decision trees, and a number of input features being sampled. During training, a random forest model may allow different decision trees to randomly sample from a dataset with replacement (e.g., from a bootstrap sample) to produce multiple final decision trees in the trained model.

For example, when multiple decision trees form an ensemble in the random forest model, this ensemble may determine more accurate predicted data, particularly when the individual trees are uncorrelated with each other. In some embodiments, a random forest model implements a software algorithm that is an extension of a bagging method. A random forest model may use both bagging and feature randomness to create an uncorrelated forest of decision trees. Feature randomness (also referred to as “feature bagging”) may generate a random subset of input features. This random subject may thereby result in low correlation among decision trees in the random forest model. In a training operation for a random forest model, a training operation may search for decision trees that provide the best split to subset particular data, such as through a classification and regression tree (CART) algorithm. Different metrics, such as information gain or mean square error (MSE), may be used to determine the quality of a data split for various decision trees.

Keeping with random forests, a random forest model may be a classifier that uses data having discrete labels or classes. Likewise, a random forest model may also be used as a random forest regressor to solve regression problems. Depending on the type of problem being addressed by the random forest model, how predicted data is determined may vary accordingly. For a regression task, the individual decision trees may be averaged in a predicted result. For a classification task, a majority vote (e.g., predicting an output based on the most frequent categorical variable) may determine a predicted class. In a random forest regressor, the model may work with data having a numeric or continuous output, which cannot be defined by distinct classes.

The trained ensemble model may be evaluated using appropriate performance metrics such as accuracy, precision, recall, and F1 score. The F1 score uses weighting factors on precision and recall to determine a mean, such as a harmonic mean, of the precision and recall. The “1” in F1 refers to applying the same weighting factor to precision and as is applied to recall, as such, F score (with no number designation) refers to an F1 score. Some embodiments may use adjusted F scores such as the F0.5 score and the F2 score, as well as the standard F1 score. For example, the “2” in F2 score indicates that recall is twice as important as precision. An F0.5 score prioritizes precision.

Model hyperparameters may be tuned using techniques like cross-validation to optimize the performance of the model. The implementation may utilize programming languages like Python™, along with relevant libraries (e.g., scikit-learn, TensorFlow) for model development, training, and evaluation. The model's performance may be assessed through rigorous validation using cross-validation, and hyperparameter tuning can be performed using techniques such as grid search or Bayesian optimization, where Bayesian refers to naïve (strong independence assumptions between features) Bayes model. Commercially available items available as of the priority date of this patent application include, for example, Python™, scikit-learn, and TensorFlow. This list is not intended to be limiting, nor are the determinations intended to be limited to the commercially available program. Any suitable software (e.g., custom-coded applications) providing similar functionality to that described may also be implemented without departing from the scope of the present disclosure.

In some embodiments, the distribution network manager may perform one or more ML algorithms (e.g., an unsupervised ML algorithm, a reinforcement ML algorithm, a self-supervised ML algorithm, etc.), based on an obtained distribution transformer age forecasting criterion and data inputs. In particular, a reinforcement learning algorithm may be a type of method that autonomously learns agent policies through multiple iterations of trials and evaluations based on data inputs. The objective of a reinforcement learning algorithm may be to learn an agent policy x that maps the state of a transformer activity (transformer operation, transformer intervention, transformer replacement, transformer maintenance activities, transformer inspections, etc.) to an electrical distribution network integrity scenario so as to maximize an expected reward J (x). A value reward may describe one or more qualities of data inputs for a particular transformer within an ageing prediction, such as a maintenance operation.

For another example, a reinforcement learning algorithm may include an action selector engine to determine commands and/or system actions based on policy data and one or more reward functions. More specifically, a reinforcement learning algorithm may train a policy to make a sequence of decisions based on the observed states of the environment to maximize the cumulative reward determined by a reward function. For example, a reinforcement learning algorithm may employ a trial-and-error procedure to determine one or more agent policies based on various agents' interaction with a complex environment. As such, a reinforcement learning algorithm may include a reward function that teaches a particular action selection engine to follow certain rules, while still allowing the reinforcement learning model to retain information learned from data inputs regarding one or more electrical distribution network integrity scenarios and one or more transformer conditions.

In some embodiments, the distribution network manager may perform a self-supervised ML algorithm to train a model based on an obtained distribution transformer age forecasting criterion and data inputs. In particular, a self-supervised learning is a subclass of unsupervised machine learning which requires only unlabeled data to provide the supervision and formulate a pretext learning task such as predicting context or image rotation for some part of the data. The objective of a self-supervised learning algorithm may force the neural network (e.g., a convolutional neural network) to learn a high-level semantic representation to solve the task of interest. For example, a self-supervised learning algorithm may calculate the similarity with semantic information of transformer intervention activity preference that is implicitly present within the distribution management network based on the distribution transformer age forecasting criterion. The self-supervised learning algorithm may then calculate the similarity between the list of electrical distribution network integrity scenarios based on one or more qualities of data inputs.

In some embodiments, a distribution network manager is used to generate an electrical distribution network integrity scenario within a distribution management network for planning, synchronizing, and optimizing the electrical distribution network integrity scenario using one or more ML algorithms (e.g., an unsupervised ML algorithm, a reinforcement ML algorithm, a self-supervised ML algorithm) to maximize operational efficiency. In some embodiments, a first electrical distribution network integrity scenario may be generated by the distribution network manager based on a predetermined distribution transformer age forecasting criterion determined by a user based on real-time observed matters (e.g., safety concerns, contract terms, current conditions, intervention scope, intervention cost, available resources, forecast weather, regulatory agencies, legal issues, etc.). The distribution network manager may apply one or more ML algorithms to adjust the predetermined distribution transformer age forecasting criterion based on new data. The distribution network manager may apply one or more ML algorithms to accommodate the adjusted distribution transformer age forecasting criterion within seconds and re-arrange different ageing predictions. The distribution network manager automatically re-calculates the electrical distribution network integrity scenario for emerging issues based on an adjusted distribution transformer age forecasting criterion. In doing so, the distribution network manager may eliminate human errors, emergency maintenance, and breakdown maintenance.

Furthermore, the distribution network manager may apply one or more ML algorithms to generate multiple electrical distribution network integrity scenarios for a plant facility of interest based on an adjusted distribution transformer age forecasting criterion by using real-time transformer data. Accordingly, a distribution network manager may have the capability to adapt to different transformer conditions and intervention plans.

In some embodiments, the adjusted electrical distribution network integrity scenario is outputted for display for a user via a graphical user interface (e.g., an operator dashboard) for a user to observe appearances, conflicts, and awareness of possible issues with the plan. For example, the distribution network manager may automatically self-feed and build a database for a historical learning process that clearly enumerates changes to an electrical distribution network integrity scenario based on newly acquired data and statistical trends.

In some embodiments, the distribution network manager may perform an unsupervised ML algorithm to train a model based on an obtained distribution transformer age forecasting criterion and data inputs. In particular, unsupervised learning requires only unlabeled data to build a compact internal representation to formulate a pattern learning task for the data inputs. The objective of an unsupervised learning algorithm may force the neural network to learn the compact internal representation (e.g., natural clusters) of data inputs based on multiple attributes to solve the task of interest. For example, an unsupervised learning algorithm builds an electrical distribution network integrity scenario and classifies the pattern of transformer activities based on an obtained distribution transformer age forecasting criterion. These natural clusters are given various priorities to solve the task. For example, a natural cluster “1” is given a “high” priority ranking when the transformer intervention activity is urgent, and all the required tools and materials are available. For another example, a natural cluster “5” is given a “low” priority ranking when the transformer intervention activity is not urgent, and all the required tools and materials are unavailable.

The unsupervised learning algorithm then classifies the list of transformer intervention activities by using multiple natural clusters for the compact internal representation based on one or more qualities of data inputs (e.g., maintenance plan X 261, xfmr data X 263, database X 268, and/or maintenance xfmr data X 266, inspection xfmr data X 267, weather xfmr data X 269) for a particular transformer (e.g., xfmr B 220) and convergence items for recommendation based on the analysis of the pattern of natural clusters that characterize the list of transformer activities. The top N natural clusters have the highest priorities are recommended as the new convergence items for the particular transformer. Accordingly, the distribution network manager X 260 may obtain data from various entities regarding current and/or future transformer operations, then transmit commands (e.g., a command Y 255) to perform the transformer operation. The commands may be transmitted to one or more control systems.

While FIGS. 1 and 2 shows various configurations of components, other configurations may be used without departing from the scope of the disclosure. For example, various components in FIGS. 1 and 2 may be combined to create a single component. As another example, the functionality performed by a single component may be performed by two or more components.

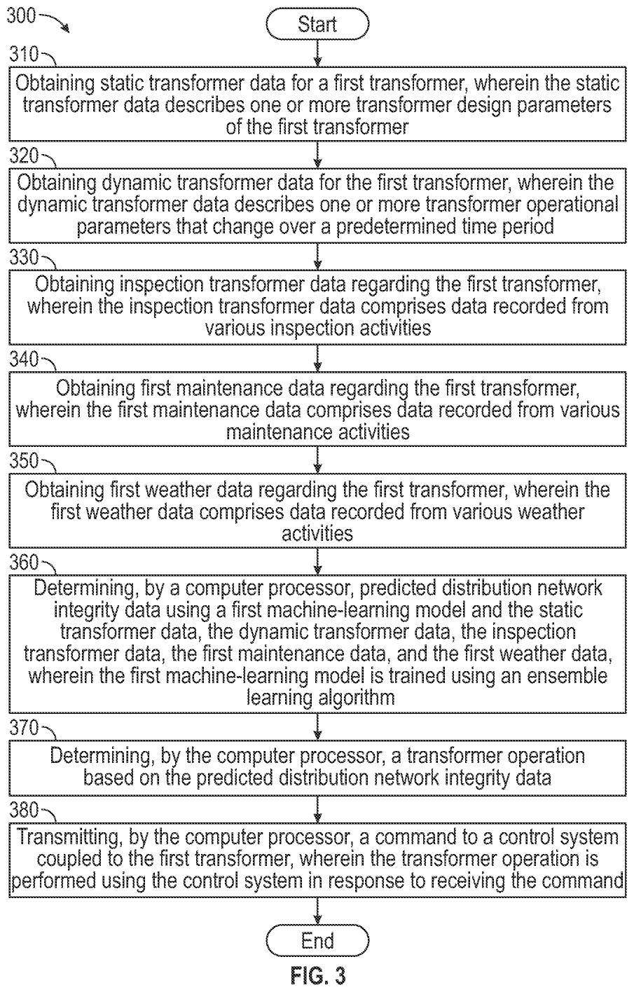

Turning to FIG. 3, FIG. 3 shows a flowchart in accordance with one or more embodiments. Specifically, FIG. 3 describes a general method for determining and/or validating an electrical distribution network integrity scenario in accordance with one or more embodiments. One or more blocks in FIG. 3 may be performed by one or more components (e.g., distribution network manager X 260) as described in FIGS. 1 and 2. While the various blocks in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

FIG. 3 is a flowchart of an example method for distribution transformer age forecasting (e.g., transformer ageing method 300). The method may include forecasting the impact on distribution transformer age caused by adding additional loads to a transformer in a plant facility. The forecasting method may use a transformer artificial intelligence (AI) predictive tool to perform steps to determine a scenario in which a transformer ageing is forecast.

At step 310, the method includes obtaining static transformer data for a first transformer, wherein the static transformer data describes one or more transformer design parameters of the first transformer. For example, the static data may be similar to the transformer data described above in FIGS. 1 and 2 and the accompanying description. For example, static data may include data such as a scannable identifier unique to the transformer (e.g., an identification code), transformer type, transformer apparent power rating (Volt-Amps or VA rating), losses rating (V×I or VI rating), transformer phase, efficiency n (e.g., output power/input power), primary voltage rating, secondary voltage rating, number of windings in primary coil, number of windings in secondary coil, cooling system specifications, bushing specifications, etc. A distribution transformer age forecasting criterion may be obtained for generating an electrical distribution network integrity scenario in accordance with one or more embodiments.

At step 320, the method includes obtaining dynamic transformer data for the first transformer, wherein the dynamic transformer data describes one or more transformer operational parameters that change over a predetermined time period. For example, dynamic data may include transformer condition data, transformer temperature data, and transformer load data. Dynamic data may include data regarding the transformer components such as the cooling system, the Buchholz relay, and the bushings.

At step 330, the method includes obtaining inspection transformer data regarding the first transformer. For example, inspection data may include data regarding various regulatory compliance entities, mechanical inspection entities, electrical inspection entities, etc.

At step 340, the method includes obtaining first maintenance data regarding the first transformer, wherein the first maintenance data comprises data recorded from various maintenance activities. For example, maintenance data may include data regarding transformer oil level, silica gel breather gel color, bushing oil level or bushing gas characteristics, and the composition of gases collected from the transformer oil such as accumulated gases at a Buchholz relay.

At step 350, the method includes obtaining first weather data regarding the first transformer, wherein the first weather data comprises data recorded from various weather activities. For example, weather data may include data from weather activities such as weather historical data research, weather predictions, weather forecasts, and weather outlooks. The weather data may include data regarding various weather characteristics such as temperature data, dust data, wind data, rain data, etc.

At step 360, the method includes determining, by a computer processor, predicted distribution network integrity data using a first machine-learning model and the static transformer data, the dynamic transformer data, the inspection transformer data, the first maintenance data, and the first weather data. The first machine-learning model is trained using an ensemble learning algorithm. The ensemble learning algorithm may use static inputs and dynamic inputs. In some embodiments the method includes using the first machine-learning model to determine second predicted distribution network integrity data for a second transformer, third predicted distribution network integrity data for a third transformer, and fourth predicted distribution network integrity data for a fourth transformer. The method may include determining a priority ranking based on the second predicted distribution network integrity data, the third predicted distribution network integrity data, and the fourth predicted distribution network integrity data. A command (e.g., a command Y 255, FIG. 2) may be transmitted to one or more control systems coupled to the one or more transformers. The commands may implement one or more various distribution network operations based on the priority ranking.

For the inspection data, the maintenance data, and the weather data, in each case the transformer data corresponds to a respective transformer, such as the first transformer, and to the entity acquiring the data that may upload the data to a server. Thus, each of the respective entities may upload their respective data to their respective server for a respective transformer.

For example, the method may include the computer processor automatically obtaining inspection data from an inspection server after the control system on an electrical distribution network uploads information regarding a completed inspection operation such as regulatory compliance data, mechanical inspection data, and electrical inspection data from respective entities of one or more inspection entities.

Likewise, the method may include the computer processor automatically obtaining maintenance data from a maintenance server after the control system on an electrical distribution network uploads information regarding a completed maintenance operation such as a transformer replacement operation, transformer intervention, a transformer repair, or other transformer maintenance activities.

In like manner the method may include the computer processor automatically obtaining weather data from a weather server after the control system on an electrical distribution network uploads information regarding a weather operation such as a weather report regarding weather temperature data, weather dust data, weather wind data, and weather rain precipitation/snow accumulation data.

Continuing with step 360, in some embodiments, an electrical distribution network integrity scenario may be generated using a distribution transformer age forecasting criterion, transformer data, inspection data, maintenance data, and/or weather data. Using different types of data, the electrical distribution network integrity scenario may be generated by a distribution network manager that accounts for various probabilities of different transformer events (such as inspection, maintenance, weather, etc.)

Continuing with step 360, in some embodiments, the distribution transformer age forecasting criterion may be obtained for generating the electrical distribution network integrity scenario. For example, a distribution network manager may obtain the distribution transformer age forecasting criterion from a database that is associated with a particular electrical distribution network integrity scenario.

Continuing with step 360, in some embodiments, a ML algorithm trains a model to build the electrical distribution network integrity scenario based on specific input features (e.g., data inputs.) For example, a distribution network may build multiple electrical distribution network integrity scenarios within seconds to accommodate multiple sets of data inputs for different electrical distribution network integrity scenarios depending on the user-defined importance of variables which are flexible to change when required (swap importance relevance of setup by weather, maintenance, inspection, condition, etc.). As another example, a distribution network manager displays the electrical distribution network integrity scenario to observe appearance, conflicts, and awareness as per setup. A distribution network manager may make decisions that the distribution transformer age forecasting criterion and/or the electrical distribution network integrity scenario need adjustment.

A distribution network manager may assess the statistical trend of data inputs as an additional value to enhance the automatic machine learning self-decision process. Thus, the distribution network manager may allow flexibility to accommodate real-time changes for any observed matters (e.g., safety concerns, government/regulatory agencies, forecast weather, legal issues, etc.) to improve robustness of the age forecast by advising about possible issues. A distribution network manager may generate and assess multiple electrical distribution network integrity scenarios for a plant facility in order to determine a better distribution transformer age forecast based on the obtained real-time data from actual processes and real events. As such, a distribution network manager accommodates substantial amount of site planning, emerging issues, and rescheduling of transformer and/or grid operations.

A determination may be made whether to update a transformer age forecasting criterion in accordance with one or more embodiments. For example, based on changing electrical loading of an electrical distribution transformer at a plant facility, a transformer age forecasting criterion may be updated to account for different real-time conditions. Where it is determined that the transformer age forecasting criterion does not need to be updated, this process may proceed to step 370. Where it is determined that the criterion needs to be updated, this process may include adjusting a transformer age forecasting criterion before returning to step 320. If the transformer age forecasting criterion needs to be updated, then it is updated based on a data input adjustment in accordance with one or more embodiments. In some embodiments, the data input adjustment is based on detecting a condition or event that affects the accuracy or likelihood of implementing a previous electrical distribution network integrity scenario.

In accordance with one or more embodiments an electrical distribution network integrity scenario and/or a transformer age forecasting criterion may be presented within a graphical user interface. For example, a distribution network manager may provide a current or new electrical distribution network integrity scenario for a user. Next to the electrical distribution network integrity scenario, the forecasting criterion with the corresponding inputs may be shown to illustrate the basis for the electrical distribution network integrity scenario.

A determination may be made whether the electrical distribution network integrity scenario is valid in accordance with one or more embodiments. In some embodiments, an electrical distribution network integrity scenario is validated upon meeting one or more acceptance criteria. In some embodiments an electrical distribution network integrity scenario may be adjusted by a distribution network manager based on an updated forecasting criterion and data inputs when the one or more acceptance criteria are not met in the current electrical distribution network integrity scenario. Where the electrical distribution network integrity scenario is invalid, this process may return to step 320. Where the electrical distribution network integrity scenario is valid, this process may proceed to step 370.

In some embodiments the computer processor may generate one or more electrical distribution network integrity scenarios that correspond to one or more different electrical distribution network integrity criteria. The distribution network manager may automatically readjust an electrical distribution network integrity criterion. If or when the computer processor detects that at least one electrical distribution network integrity criterion among a set of different electrical distribution network integrity criteria is satisfied, then the computer processor may generate one or more electrical distribution network integrity scenarios that correspond to one or more different electrical distribution network integrity criteria and then, using new transformer data (i.e., dynamic inputs) automatically select an electrical distribution network integrity scenario from among one or more electrical distribution network integrity scenarios.

At step 370, the method includes determining, by the computer processor, a transformer operation based on the predicted distribution network integrity data. Specifically, the method may determine an adjusted parameter regarding a transformer operation. For example, the method may determine an adjusted parameter regarding a cooling system parameter such as a fan speed.

At step 380, the method includes transmitting, by the computer processor, a command to a control system coupled to the first transformer, wherein the transformer operation is performed using the control system in response to receiving the command. For example, the method may perform, using the control system, the adjusted parameter regarding a cooling system parameter such as the fan speed. In accordance with one or more embodiments a distribution network manager may communicate with one or more control systems at a plant facility to implement various sub-tasks in an electrical distribution network integrity scenario per one or more of an acceptance criterion such as a user desire such as a desired timeline.

In some embodiments, a distribution network manager may perform the process described in FIG. 3 above using data inputs based on static data, dynamic data, weather data, maintenance data, inspection data, a scope of work for a transformer operation, a cost of the transformer operation, and various restrictions (such as capital improvement planning, etc.). For example, the distribution network manager may independently access each data input in the context of a distribution transformer age forecasting criterion (e.g., assign the data input no weight or significant weight.) The distribution network manager may process the various data inputs in order to discard various cases that cannot satisfy a particular age forecasting criterion. The distribution network manager may arrange the possible electrical distribution network integrity scenarios to restrict and/or arrange multiple options in an electrical distribution network integrity scenario. Once an electrical distribution network integrity scenario is built, an electrical distribution network integrity scenario may provide a schedule of various tasks for implementing the electrical distribution network integrity scenario. The electrical distribution network integrity scenario may be displayed with various conflicts and awareness being highlighted. The distribution network manager may decide if an adjustment is needed based on newly acquired data or a new analysis of existing data. Likewise, the distribution network manager may send a request to a user device for feedback regarding the existing electrical distribution network integrity scenario. Once a final electrical distribution network integrity scenario with a final distribution transformer age forecast is drafted, the forecast may proceed to final approval. At final approval, a distribution network manager may validate the forecast based on one or more of an acceptance criterion. In some embodiments, the transformer intervention forecast may be approved and/or revised by users.

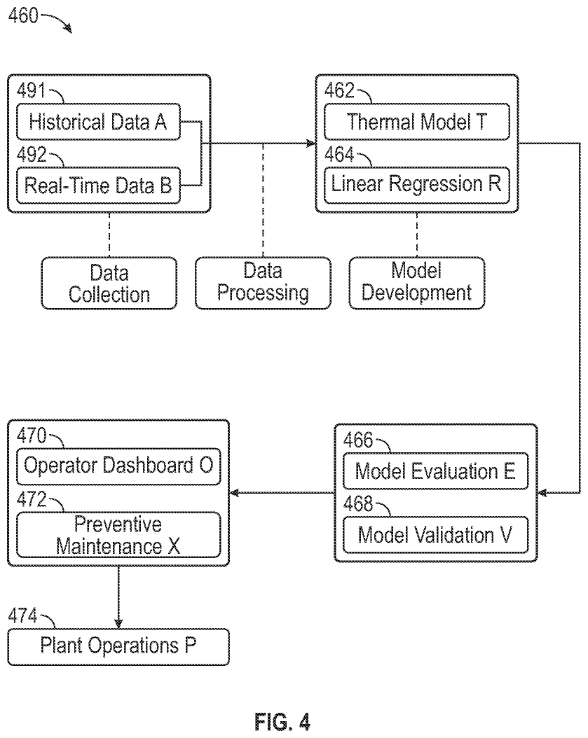

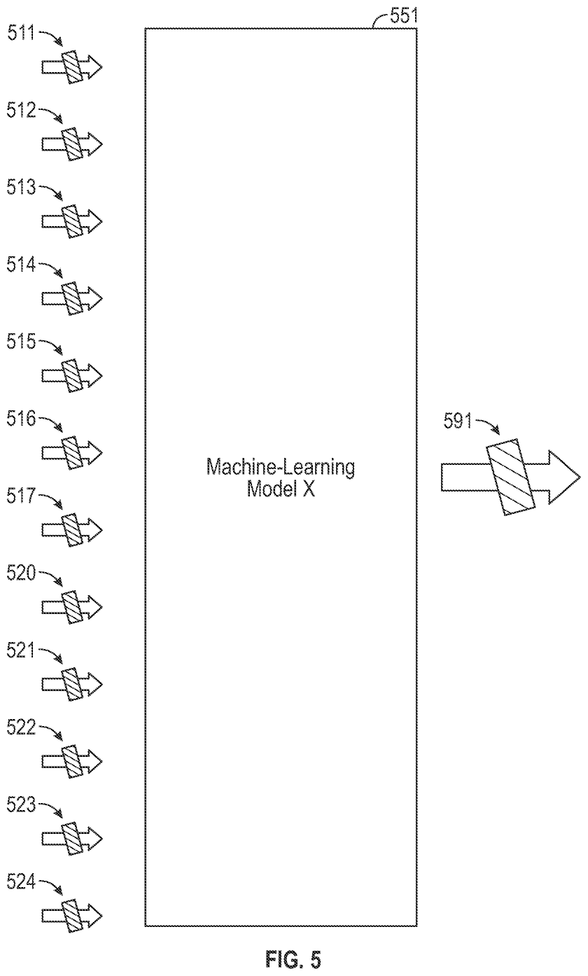

Turning to FIGS. 4 and 5, FIGS. 4 and 5 provide examples of a ML model in accordance with one or more embodiments. The following example is for explanatory purposes only and not intended to limit the scope of the disclosed technology. FIG. 4 illustrates a distribution network manager (e.g., a distribution network manager X 460) that obtains, acquires, or collects historical data (e.g., historical data A 491) and real-time data (e.g., real-time data B 492). The distribution network manager may obtain user data such as one or more of an acceptance criterion and/or one or more of a distribution transformer age forecasting criterion.

Using a machine learning algorithm, the distribution network manager processes the data (e.g., a data processing function), then develops a model (e.g., a model development function) using a thermal model (e.g., a thermal model T 462) and a linear regression model (e.g., a linear regression R 464). The distribution network manager may then evaluate the model (e.g., a model evaluation E 466) and validate the model (e.g., a model validation V 468). The distribution network manager may then present the model as an electrical distribution network integrity scenario on an operator dashboard O 470. The electrical distribution network integrity scenario may be coupled to a preventive maintenance subsystem (e.g., a preventive maintenance system X 472.)

The distribution network manager may adjust the data inputs for the electrical distribution network integrity scenario to generate an adjusted distribution transformer age forecasting criterion. Accordingly, the original electrical distribution network integrity scenario may be revised to generate an adjusted electrical distribution network integrity scenario using the adjusted distribution transformer age forecasting criterion. Likewise, the adjusted electrical distribution network integrity scenario may be used to modify plant operations (e.g., plant operations P 474).

Turning to FIG. 5, FIG. 5 provides an example of an ML model in accordance with one or more embodiments. The following example is for explanatory purposes only and not intended to limit the scope of the disclosed technology. In FIG. 5, FIG. 5 illustrates a machine-learning model X 551 that obtains various inputs. The inputs include data for transformer static inputs and dynamic inputs, grid data, weather data, maintenance data, and inspection data. In this example, FIG. 5 shows inputs including grid system data (e.g., grid system data A 511), transformer condition data (e.g., transformer condition data A 512), transformer coils data (e.g., xfmr coils data A 513), transformer core data (e.g., xfmr core data A 514), transformer windings data (e.g., xfmr windings data A 515), transformer conservator data (e.g., xfmr conservator data A 516), transformer bushing data (e.g., xfmr bushing data A 517), transformer operational data (e.g., xfmr operational data X 520), weather data (e.g., weather xfmr data A 521), maintenance transformer data A (e.g., maintenance xfmr data A 522), inspection transformer data (e.g., inspection xfmr data A 523).

The distribution network manager may modify data inputs for an electrical distribution network integrity scenario. The following examples are for explanatory purposes only and not intended to limit the scope of the disclosed technology. Using a machine-learning algorithm, the machine-learning model X 551 monitors and adjusts the underlying data for the various inputs to forecast the impact of adding additional loads in the plant facility on distribution transformer age and thereby to generate a predicted distribution network integrity (e.g., a predicted distribution network integrity data 591) of the selected network. Accordingly, the inputs are revised to generate a transformer operation using the various inputs. Likewise, the predicted distribution network integrity data is used to modify transformer operations at the selected transformer.

In general, static data, e.g., static transformer data, describes one or more transformer design parameters of a transformer and dynamic data, e.g., dynamic transformer data, describes one or more transformer properties that change over a predetermined time period. For example, the grid system data A 511 may include dynamic data such as the measured electrical loads on the grid and specifically, loading of a transformer and additional loads in the plant facility on a transformer.

The transformer condition data may include data from transformer monitoring characteristics such as partial discharge (PD) indicating potential insulation failure, OLTC monitoring, bushing oil and moisture, dissolved gas analysis, temperatures, hot spot temperatures, and moisture.

Transformer coils data (e.g., xfmr coils data A 513) may include static data such as the quantity of coils and dynamic data such as temperatures of the coils. Likewise, the transformer core data (e.g., xfmr core data A 514) may include static data such as design data (e.g., shell-type where the core surrounds the windings, and core-type where the windings surround the core steel, limb quantity, distributed gap, laminated/stacked core, amorphous and nanocrystalline core, etc.) Transformer core data may include dynamic data such as the temperature of the core. In like manner transformer windings data (e.g., xfmr windings data A 515), transformer conservator data (e.g., xfmr conservator data A 516), and transformer bushing data (e.g., xfmr bushing data A 517) may include static data and dynamic data. Transformer bushing data may include static data such as a predetermined oil level and pressure, and dynamic data such as measured oil level and measured pressure.

The operational conditions (e.g., xfmr operational data X 520) may include operational parameters such as electrical loading, temperatures, pressures, moisture content, dissolved gas analysis, shutdowns planned and unplanned, capital improvements planned, and other operational events or interventions.

Weather transformer data (e.g., the weather xfmr data A 521) may include weather temperature data, weather dust data, weather wind data, weather rain data, etc.

Maintenance transformer data (e.g., the maintenance xfmr data A 522) may include historical transformer data, transformer intervention data, transformer repair data, and other maintenance activities data.

Inspection transformer data (e.g., the xfmr inspection data A 523) may include historical transformer inspection data obtained from records of various inspection activities, transformer interventions, and transformer repairs. Inspection data may include, for example, regulatory compliance inspection data, mechanical inspection data, electrical inspection data, etc. Regulatory compliance inspection data may include reports citing correspondence with codes, observations compared with codes, and findings that do not meet codes. Mechanical inspection data may include structural, coating, corrosion, fastener torque, dissolved gas analysis, oil levels, silica gel breather inspection, pressure levels, seal inspection, etc. Electrical inspection data may include voltage testing, current draw testing, partial discharge testing, degree of polymerization inspection.

The time-series information (e.g., transformer time-series data X 524) may include historical trends of loading, temperature, pressure, oil level, and other relevant variables. The relevant data may include both problematic and non-problematic grid and/or transformer examples. The transformer data are collected and prepared for training the model. Data preprocessing techniques may be applied to handle missing values, outliers, and normalization. This comprehensive approach ensures that relevant factors influencing transformer ageing issues are considered during the prediction process.

The output variable of the machine-learning model X 551 may include a classification output representing a predicted risk that a selected transformer may be problematic; i.e., some embodiments may predict transformer ageing issues. The output variable is a binary label indicating whether a transformer is classified as problematic (1) or non-problematic (0) regarding the ageing issues. This prediction serves as a proactive assessment of the integrity of the transformer and aids in making informed decisions about maintenance and operational planning. The model obtains the relevant input variables as inputs and then the model outputs the binary classification label, indicating a transformer integrity forecast of whether or not the transformer is likely to have an ageing problem, and thus an impact on the predicted distribution integrity of the selected network. The transformer being problematic or non-problematic may be used for the integrity scenario.

This forecast supports the predicting, the decision-making, and the scheduling related to transformer ageing and thereby distribution network integrity management, maintenance prioritization, and operational planning. The model may incorporate features to enable an output indicating the degree to which the transformer may be problematic (and the inverse, non-problematic.) An output may be, for example, data regarding predicted transformer integrity of a selected transformer (e.g., the predicted distribution network integrity data 591 of the selected network). Another output may be a transformer operation. Various machine-learning models may be used such as an initial machine-learning model, a first machine-learning model, and a second, third, and fourth, etc., machine-learning model.

Embodiments may be implemented on a computer system. FIG. 6 is a block diagram of a computer system (e.g., the computer 602) used to provide computational functionalities associated with described algorithms, methods, functions, processes, flows, and procedures as described in the instant disclosure, according to an implementation. The illustrated computer (e.g., the computer 602) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 602 may include a computer that includes an input device, such as a keypad, keyboard, touch screen, or other device that can accept user information, and an output device that conveys information associated with the operation of the computer 602, including digital data, visual, or audio information (or a combination of information), or a GUI.

The computer 602 can serve in a role as a client, network component, a server, a database or other persistency, or any other component (or a combination of roles) of a computer system for performing the subject matter described in the instant disclosure. The illustrated computer (e.g., the computer 602) is communicably coupled with a network 616. In some implementations, one or more components of the computer 602 may be configured to operate within environments, including cloud-computing-based, local, global, or other environment (or a combination of environments).

At a high level, the computer 602 is an electronic computing device operable to receive, transmit, process, store, or manage data and information associated with the described subject matter. According to some implementations, the computer 602 may also include or be communicably coupled with an application server, e-mail server, web server, caching server, streaming data server, business intelligence (BI) server, or other server (or a combination of servers).

The computer 602 can receive requests over network 616 from a client application (for example, executing on another computer 602) and responding to the received requests by processing the said requests in an appropriate software application. In addition, requests may also be sent to the computer 602 from internal users (for example, from a command console or by other appropriate access method), external or third-parties, other automated applications, as well as any other appropriate entities, individuals, systems, or computers.

Each of the components of the computer 602 can communicate using a system bus 604. In some implementations, any or all of the components of the computer 602, both hardware or software (or a combination of hardware and software), may interface with each other or with an interface 606 (or a combination of both) over the system bus 604 using an application programming interface (API) (e.g., an API 612) or a service layer 614 (or a combination of the API 612 and service layer 614. The API 612 may include specifications for routines, data structures, and object classes. The API 612 may be either computer-language independent or dependent and refer to a complete interface, a single function, or even a set of APIs. The service layer 614 provides software services to the computer 602 or other components (whether or not illustrated) that are communicably coupled to the computer 602. The functionality of the computer 602 may be accessible for all service consumers using this service layer. Software services, such as those provided by the service layer 614, provide reusable, defined business functionalities through a defined interface. For example, the interface may be software written in JAVA, C++, or other suitable language providing data in extensible markup language (XML) format or other suitable format. While illustrated as an integrated component of the computer 602, alternative implementations may illustrate the API 612 or the service layer 614 as stand-alone components in relation to other components of the computer 602 or other components (whether or not illustrated) that are communicably coupled to the computer 602. Moreover, any or all parts of the API 612 or the service layer 614 may be implemented as child or sub-modules of another software module, enterprise application, or hardware module without departing from the scope of this disclosure.

The computer 602 includes the interface 606. Although illustrated as a single interface in FIG. 6, two or more of the interface 606 may be used according to particular needs, desires, or particular implementations of the computer. The interface 606 is used by the computer 602 for communicating with other systems in a distributed environment that are connected to the network 616. Generally, the interface (604 includes logic encoded in software or hardware (or a combination of software and hardware) and operable to communicate with the network 616. More specifically, the interface 606 may include software supporting one or more communication protocols associated with communications such that the network 616 or interface's hardware is operable to communicate physical signals within and outside of the illustrated computer (e.g., the computer 602).

The computer 602 includes at least one computer processor (a computer processor 618). Although illustrated as a single computer processor in FIG. 6, two or more processors may be used according to particular needs, desires, or particular implementations of the computer. Generally, the computer processor 618 executes instructions and manipulates data to perform the operations of the computer and any algorithms, methods, functions, processes, flows, and procedures as described in the instant disclosure.

The computer 602 also includes a memory 608 that holds data for the computer or other components (or a combination of both) that can be connected to the network 616. For example, memory 608 can be a database storing data consistent with this disclosure. Although illustrated as a single memory in FIG. 6, two or more memories may be used according to particular needs, desires, or particular implementations of the computer 602 and the described functionality. While memory 608 is illustrated as an integral component of the computer 602, in alternative implementations, memory 608 can be external to the computer 602.

The application 610 is an algorithmic software engine providing functionality according to particular needs, desires, or particular implementations of the computer 602, particularly with respect to functionality described in this disclosure. For example, the application 610 can serve as one or more components, modules, applications, etc. Further, although illustrated as a single application, the application may be implemented as multiple applications on the computer 602. In addition, although illustrated as integral to the computer 602, in alternative implementations, the application 610 can be external to the computer 602.

There may be any number of the computer 602 associated with, or external to, a computer system containing computer 602, each computer 602 communicating over network 616. Further, the term “client,” “user,” and other appropriate terminology may be used interchangeably as appropriate without departing from the scope of this disclosure. Moreover, this disclosure contemplates that many users may use one of the computer 602, or that one user may use multiple computers.

In some embodiments, the computer 602 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed:

1. A method, comprising:
obtaining static transformer data for a first transformer,
wherein the static transformer data describes one or more transformer design parameters of the first transformer;
obtaining dynamic transformer data for the first transformer,
wherein the dynamic transformer data describes one or more transformer operational parameters that change over a predetermined time period;
obtaining inspection transformer data regarding the first transformer,
wherein the inspection transformer data comprises data recorded from various inspection activities;
obtaining first maintenance data regarding the first transformer;
wherein the first maintenance data comprises data recorded from various maintenance activities;
obtaining first weather data regarding the first transformer;
wherein the first weather data comprises data recorded from various weather activities;
determining, by a computer processor, predicted distribution network integrity data using a first machine-learning model and the static transformer data, the dynamic transformer data, the inspection transformer data, the first maintenance data, and the first weather data, wherein the first machine-learning model is trained using an ensemble learning algorithm;
determining, by the computer processor, a transformer operation based on the predicted distribution network integrity data; and
transmitting, by the computer processor, a command to a control system coupled to the first transformer, wherein the transformer operation is performed using the control system in response to receiving the command.

2. The method of claim 1, further comprising:
obtaining training data for a plurality of transformers, wherein the training data comprises second static transformer data, second dynamic transformer data, second inspection transformer data, second maintenance transformer data, second weather transformer data; and
performing, using a plurality of machine-learning epochs and the training data, a training operation of an initial model to produce a second machine-learning model.

3. The method of claim 1, further comprising:
wherein the first machine-learning model is a random forest model comprising a plurality of decision tree nodes coupled,
wherein the first machine-learning model is trained using a bootstrap and aggregation operation.

4. The method of claim 1, further comprising:
generating, by the computer processor, a plurality of electrical distribution network integrity scenarios that correspond to a plurality of different electrical distribution network integrity criteria;
selecting, automatically by the computer processor and based on new transformer data, an electrical distribution network integrity scenario among the plurality of electrical distribution network integrity scenarios in response to detecting at least one electrical distribution network integrity criterion among the plurality of different electrical distribution network integrity criteria is satisfied; and
selecting, by the computer processor and from among the plurality of electrical distribution network integrity scenarios, a first electrical distribution network integrity scenario to implement.

5. The method of claim 1, further comprising:
presenting, by a user device using a graphical user interface, the predicted distribution network integrity data; and
obtaining, in response to a user input within the graphical user interface, a user selection of the predicted distribution network integrity data,
wherein the command is transmitted in response to the user selection.

6. The method of claim 1,
obtaining, from a maintenance server, the first maintenance data regarding a plurality of transformers, and
wherein the first maintenance data describes a respective maintenance status of a respective transformer of interest among the plurality of transformers and a respective time period that the respective transformer of interest was operating,
wherein the computer processor generates the predicted distribution network integrity data using the first maintenance data.

7. The method of claim 1,
obtaining, from a remote server, the inspection transformer data regarding a plurality of inspection operations, wherein at least one inspection operation among the plurality of inspection operations is a degree of polymerization inspection,
wherein the predicted distribution network integrity data is generated using the inspection transformer data.

8. The method of claim 1,
wherein the inspection transformer data comprises regulatory compliance data, mechanical inspection data, and electrical inspection data from respective entities of a plurality of inspection entities.

9. The method of claim 1,
wherein the inspection transformer data is obtained automatically using the computer processor.

10. The method of claim 1, further comprising:
automatically obtaining maintenance data from a maintenance server after the control system on an electrical distribution network uploads information regarding a completed maintenance operation.

11. The method of claim 1, further comprising:
detecting, by the computer processor based on the predicted distribution network integrity data, a transformer failure of a first transformer;
determining, by the computer processor, a transformer replacement operation; and
replacing the first transformer with a second transformer.

12. The method of claim 1, further comprising:
determining, using the first machine-learning model, second predicted distribution network integrity data for a second transformer, third predicted distribution network integrity data for a third transformer, and fourth predicted distribution network integrity data for a fourth transformer;
determining a priority ranking based on the second predicted distribution network integrity data, the third predicted distribution network integrity data, and the fourth predicted distribution network integrity data; and
transmitting commands to a plurality of control systems coupled to the second transformer, the third transformer, and the fourth transformer, wherein the commands implement a plurality of distribution network operations based on the priority ranking.

13. A system, comprising:
a plurality of servers;
an electrical distribution site; and
a distribution network manager coupled to the plurality of servers and to the electrical distribution site, the distribution network manager comprising a computer processor, wherein the distribution network manager comprises functionality for:
obtaining static transformer data for a first transformer,
wherein the static transformer data describes one or more transformer design parameters of the first transformer;
obtaining dynamic transformer data for the first transformer,
wherein the dynamic transformer data describes one or more transformer operational parameters that change over a predetermined time period;
obtaining inspection transformer data regarding the first transformer,
obtaining first maintenance data regarding the first transformer;
wherein the first maintenance data comprises data recorded from various maintenance activities;
determining, by a computer processor, predicted distribution network integrity data using a first machine-learning model and the static transformer data, the dynamic transformer data, the inspection transformer data, and the first maintenance data, wherein the first machine-learning model is trained using an ensemble learning algorithm;
wherein the ensemble learning algorithm uses static transformer data and dynamic transformer data,
determining, by the computer processor, a transformer operation based on the predicted distribution network integrity data; and
transmitting, by the computer processor, a command to a control system coupled to the first transformer, wherein the transformer operation is performed using the control system in response to receiving the command.

14. The system of claim 13, further comprising:
an electrical distribution network coupled to the distribution network manager,
wherein the distribution network manager further comprises functionality for:
obtaining training data for a plurality of transformers, wherein the training data comprises second static transformer data, second dynamic transformer data, second inspection transformer data, second maintenance transformer data, second weather transformer data; and
performing, using a plurality of machine-learning epochs and the training data, a training operation of an initial model to produce a second machine-learning model.

15. The system of claim 13, wherein the distribution network manager further comprises functionality for:
generating, by the computer processor, a plurality of electrical distribution network integrity scenarios that correspond to a plurality of different electrical distribution network integrity criteria;
selecting, automatically by the computer processor and based on new transformer data, an electrical distribution network integrity scenario among the plurality of electrical distribution network integrity scenarios in response to detecting at least one electrical distribution network integrity criterion among the plurality of different electrical distribution network integrity criteria is satisfied; and
selecting, by the computer processor and from among the plurality of electrical distribution network integrity scenarios, a first electrical distribution network integrity scenario to implement.

16. The system of claim 13, further comprising:
a user device coupled to the distribution network manager,
wherein the user device presents, using a graphical user interface, the predicted distribution network integrity data, and
wherein the user device obtains, in response to a user input within the graphical user interface, a user selection of the predicted distribution network integrity data,
wherein the command is transmitted in response to the user selection.

17. The system of claim 13,
wherein the plurality of servers comprises a maintenance server, and
wherein the distribution network manager further comprises functionality for:
obtaining, from a maintenance server, the first maintenance data regarding a plurality of transformers,
wherein the first maintenance data describes a respective maintenance status of a respective transformer of interest among the plurality of transformers and a respective time period that the respective transformer of interest was operating,
wherein the computer processor generates the predicted distribution network integrity data using the first maintenance data.

18. The system of claim 13,
wherein the plurality of servers comprises a remote server,
wherein the distribution network manager further comprises functionality for:
obtaining, from the remote server, the inspection transformer data regarding a plurality of inspection operations, wherein at least one inspection operation among the plurality of inspection operations is a degree of polymerization inspection,
wherein the predicted distribution network integrity data is generated using the inspection transformer data.

19. The system of claim 13,
wherein the inspection transformer data is obtained automatically using the computer processor.

20. The system of claim 13,
wherein the distribution network manager further comprises functionality for:
automatically obtaining maintenance data from a maintenance server after the control system on an electrical distribution network uploads information regarding a completed maintenance operation.
